(19) United States
(12) Patent Application Publication
(10) Pub. No.: US 2026/0319522 A1
(43) Pub. Date: Oct. 15, 2026

(54) State and Model Transfer Between Vehicles in Network

(71) Applicant: TurbineOne, Inc., San Francisco, CA (US)

(72) Inventors: Daniel Hebb, San Diego, CA (US); Matthew Warren Amacker, Santa Clara, CA (US); Keith Joseph Goldberg, Winter Park, FL (US)

(21) Appl. No.: 19/644,886

(22) Filed: Apr. 10, 2026

Related U.S. Application Data
(60) Provisional application No. 63/789,125, filed on Apr. 15, 2025.

(51) Int. Cl. G05D 1/69; G05D 1/226; G08G 9/00; H04L 67/12

(52) U.S. Cl. CPC G05D 1/69; G05D 1/226; G08G 9/00; H04L 67/12

(57) ABSTRACT

A network of nodes includes a command node and a set of operational nodes that are vehicles configured to travel through an environment and communicate with each other. Instructions from the command node are transmitted to one or more of the vehicles in the network. The instructions include state updates for the vehicles. The instructions are propagated asynchronously through the network by enabling vehicles that receive the instructions to transmit the instructions to other vehicles as the vehicles travel through the environment.

### CROSS-REFERENCE TO RELATED APPLICATION

This application claims the benefit of, and priority to, U.S. Provisional Patent Application Ser. No. 63/789,125, “State and Model Transfer Between Vehicles,” filed on Apr. 15, 2025, the subject matter of which is incorporated herein by reference in its entirety.

### TECHNICAL FIELD

This disclosure relates generally to networks of nodes operating in an environment, and more particularly, to asynchronous communications between nodes in the network.

### BACKGROUND

Autonomous vehicles and unmanned systems are required to maintain direct communication with a central command system to receive operational instructions as they operate in an environment. However, in many cases maintaining such communication and operational control is difficult due to lack of infrastructure and environmental considerations as to where those vehicles and unmanned systems operate.

### BRIEF DESCRIPTION OF THE DRAWINGS

Embodiments of the disclosure have other advantages and features which will be more readily apparent from the following detailed description and the appended claims, when taken in conjunction with the examples in the accompanying figure (FIGS.) (or drawings), in which:

FIG. 1A is a diagram of a network of nodes operating in an environment, according to one or more embodiments.

FIG. 1B is similar to FIG. 1A except it additionally illustrates how information (e.g., state updates or object detections) propagates through the network, according to one or more embodiments.

FIG. 2 is a diagram illustrating information communication between a command node and a set of three nodes, according to one or more embodiments.

FIG. 3 is a diagram of a node of the network traveling through the environment and communicating with other nodes in the network, according to one or more embodiments.

FIGS. 4A-4C are diagrams that illustrate an example of nodes traveling in a pattern to increase communication efficiency across the network, according to one or more embodiments.

FIGS. 5A-5B are diagrams that illustrate nodes traveling to a meeting location to communicate updates to each other, according to one or more embodiments.

FIG. 5C illustrates node A with a circular travel route that intersects routes of the other operational nodes in the network, according to one or more embodiments.

FIG. 6 is a block diagram of a node, according to one or more embodiments.

FIG. 7 is a first flowchart illustrating an algorithm for a state and model update executed by a node, according to one or more embodiments.

FIG. 8 is a second flowchart, according to one or more embodiments.

FIG. 9 is a third flowchart, according to one or more embodiments.

FIG. 10 is a fourth flowchart, according to one or more embodiments.

FIG. 11 is a block diagram an example machine able to read instructions from a machine-readable medium and execute them in a set of one or more processors (or controllers), according to one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

### Configuration Overview

Some embodiments relate to a network of nodes that includes a command node and a set of operational nodes that are vehicles configured to travel through an environment and communicate with each other. Instructions from the command node are transmitted to one or more of the vehicles in the network. The instructions include state updates for the vehicles. The instructions are propagated asynchronously through the network by enabling vehicles that receive the instructions to transmit the instructions to other vehicles as the vehicles travel through the environment.

### Network of Nodes

A fleet of nodes can communicate with each other to form a network (e.g., an ad-hoc, peer-to-peer, and/or mesh network). The nodes may be vehicles (e.g., autonomous vehicles). Example vehicles include aerial vehicles (e.g., drones, satellites), maritime or aquatic vehicles (e.g., boats, ships, submarines), and land vehicles (e.g., automobiles, trucks, busses, trains).

There may be two types of nodes (e.g., machines) in a network, for example, a command and control (“C2”) node and one or more operational nodes (e.g., a fleet of vehicles). The C2 node can transmit instructions (e.g., a state update) to the operational nodes in the network. Among other advantages, after a first operational node receives an instruction from the C2 node (or another operational node in the network), that first node can then propagate that instruction to other operational nodes in the network that haven't received the update, even if those nodes are not within communication range or line-of-sight of the C2 node, thus enabling instructions to quickly and asynchronously propagate through a network. This contrasts with waiting until each node (e.g., autonomously) comes within communication range of the C2 node to receive instructions. Conceptually, an instruction can be thought of as an infection that spreads across nodes in the network as nodes come within communication range of each other. Nodes may even perform operations to help increase the spread rate of the instructions across the network.

Nodes in the network may be working individually or collectively to perform a mission objective. A mission objective may be specified by the C2 node. A mission objective specifies a particular task or goal for one or more nodes to accomplish, such as detecting a specific type of object in the environment. Example mission objectives may be to detect boats, land vehicles, humans, or other targets of interest using sensor data and machine learned models. Object detections made by a node for a mission objective may subsequently be transmitted to the C2 node.

An operational node may operate according to its current state. A state specifies a mission objective for one or more operational nodes of the network to pursue. A state may also specify actions for those nodes to perform to achieve a mission objective and actions to perform after a mission objective is achieved. In some embodiments, a state specifies a (e.g., machine learned object detection) model to be used to achieve a mission objective (the model may be referred to as being associated with the state). An instruction generated by the C2 node can include an updated state. Thus, upon receiving an instruction with an updated state (from the C2 node or another node), an operational node may update its state in accordance with the instruction.

In one example, one or more nodes (e.g., each node) generate data describing the external environment from one or more sensors coupled (e.g., mounted) to the nodes. Example types of data include one or more images, one or more video frames, audio data, or any combination thereof. The nodes may apply a model (e.g., a machine learned object detection model) associated with a mission objective to the data. Example object detection models include a boat detection model, a land vehicle detection model, and a human detection model. An object detection model may be a YOLO (you only look once) model.

During operations, operational nodes may regularly “ping” (transmission of a communication signal) each other, e.g., when they are in communication range, to determine whether there are any new instructions from the C2 node. The pings may be pull requests (e.g., a first node pings a second node to provide its current state) or push requests (e.g., a first node pings a second node with the current state of the first node). If a second node has an updated state, then the first node may update its state to match the state of the second node. Among other advantages, nodes sending out regular pings enables new instructions from the C2 node to quickly and asynchronously propagate through the network. Furthermore, instructions (such as state updates) may be small packets of data (e.g., less than 10, 20, 30, 40, or 50 Bytes), which enable the instructions to be transferred quickly and potentially across larger distances between nodes.

In some embodiments, if an operational node receives multiple instructions (e.g., from different nodes), the node may determine which instruction to follow based on a timestamp or version number of each instruction. For example, the node follows the instruction with the most recent timestamp or version number. A timestamp or version number for an instruction corresponds to when the instruction was generated by the C2 node.

Models (e.g., object detection models) in addition to instructions may be communicated between nodes on the network. After a node updates its state (e.g., responsive to receiving a state update from another node), it determines whether it has a model associated with that state (e.g., to perform the new objective associated with the updated state). If not, then the node can send pull requests to other nodes in the network to receive the model. While state updates between nodes may be communicated via push notifications, a model transfer may be a pull operation to prevent or eliminate nodes pushing a model to other nodes that already have that model, thus making the network more resource and time efficient.

In some embodiments, a first node (e.g., each node) prefers to receive an instruction or model directly from the C2 node. If (a) the C2 node is outside of communication range, (b) the C2 node is larger than a threshold distance away, (c) another node is (e.g., significantly) closer than the C2 node, or (d) any combination thereof, then the first node may request an instruction or model from a node other than the C2 node (e.g., the closest neighboring node). If that node does not have a desired model, then the first node may look for the model from another node.

In some embodiments, multiple different models may be associated with a state (e.g., may used to work toward the same mission objective). During model propagation, a node may receive one or more of those models. In a first example, any of the models associated with the state can be used by a node. In a second example, since models may be specialized, designed, or trained for a specific data type or hardware type (e.g., camera type) a node may receive a model configured to be used with data generated by that node and/or the hardware of that node (e.g., the type of camera coupled to the node). In another example, if a first model is configured to perform object detection at a first elevation and a second model is configured to perform object detection at a second elevation, a node may retrieve one of the models based on its current or projected elevation. In another example, for a set of models each associated with a state, the models are ranked according to preference. Thus, a model may aim to retrieve models in the set according to the ranking (e.g., the model seeks the top ranked model, but if that model isn't available, then it seeks the second ranked model).

In some embodiments, an operational node performs one or more movement maneuvers to receive instructions (e.g., a state update or model). For example, the node moves toward the C2 node or another node. In another example, the node travels to a predetermined meeting point (e.g., which is closer than the location of the C2 node) that other nodes are expected to also travel to, thus enabling the nodes at that meeting point to exchange information (e.g., state updates or models). In some updates, a state update includes a list of nodes which have the associated model. Thus, a first node that receives a state update and needs the associated model may travel to one of the nodes on the list which has the associated model. If the location of a given node is not known, the first node may interrogate the network to determine the location of a given node (e.g., asking neighbor nodes if they know the location of the given node). In contrast, in some embodiments, a node continues operations in accordance with its previous state until that node receives the model associated with its updated state.

During model propagation, an entire model may be transferred between nodes. However, in some embodiments, less than the entire model may be transferred. For example, the bottom X number of layers of the model (e.g., the model is a neural network) are transferred from one node to another, where X is an integer number greater than zero but less than the total number of layers of the model (e.g., X is two, three, four, or five). For example, a file specifying the weight values for nodes of the bottom X layers is transferred between two nodes. The layers for the remaining layers of the model may not be transferred to the receiving node and/or may already be stored on the receiving node (e.g., each node in the network). In this way, a model transfer between nodes may be considered a model update or model upgrade. Note that the “bottom” X layers of a model may refer to the final or last X layers of a model. Said differently, the “bottom” X layers of a model may refer to the X layers closest to the output data of the model.

Weight values for the remaining layers (e.g., layers other than the bottom X layers) may remain unmodified after or during a model transfer since the remaining layers are the same or generally the same across different object detection models. The bottom X layers take the output of those remaining layers and filter that output to the classes of interest for a given model (e.g., a boat, car, tree, or human). Thus, transferring the bottom X layers is sufficient for a node to modify or update an object detection model to identify a different object.

Among other advantages, transferring X layers of a model may increase transfer speeds due to less data being transferred (e.g., the data is less than 10, 20, or 30 megabytes (MB)). Also, this may increase flexibility, decrease complexity, and support backward compatibility with different model versions. For example, if a first set of nodes are running YOLO 5 and a second set of nodes are running YOLO 4, the X layers transferred between nodes may be compatible with both versions of the YOLO model. Additionally, weight values from the X layers may be applicable for different model architectures, platforms, and languages (if nodes are using models with different architectures, platforms, or languages) because the weight values from the transfer can be inserted into in the weights of whatever model the node has. In other words, weight values of a model may be agnostic to the model architecture, platform, or language.

Although the above descriptions refer to transferring layers of a model (e.g., via weight values), other types of data may be transferred between nodes to communicate a model, such as embeddings or feature sets.

An example scenario includes a network with a C2 node in a trailer operating base with 15 drones flying around (which are also nodes of the network). Some of the drones are within direct communication range of the C2 node, but some are so far away that they are unable to directly communicate with the C2 node. Thus, the C2 node may wait for those drones to autonomously return within range before the C2 node can provide a new instruction (e.g., a new mission objective and any associated models) to those drones. However, drones that receive an instruction (e.g., from the C2 node) can provide that instruction directly to other drones, thus enabling updates to quickly propagate through the network as illustrated in the following example. In a first mission objective, the drones in the network are looking for a particular ship. For example, the drones are moving through the external environment, capturing images of the environment, and using an object detection model trained to detect that particular ship. However, the C2 node changes the mission objective so that the drones should now look for jet skis. This may be the result of a user interacting with a user interface that provides instructions to the C2 node. To work toward this new mission objective, each drone may need an object detection model trained to detect jet skis (“jet ski model”). Assuming none of the drones have the jet ski model, the model is automatically propagated to all of the drones, including those outside of direct communication range of the C2 node. Drones connected to the C2 node receive the jet ski model. Drones with the jet ski model can then share the model with other drones in proximity that don't have the jet ski model, even if those drones are outside of communication range of the C2 node. Thus, this asynchronous update allows the entire network to quickly update (e.g., their targets).

Failure scenarios may be handled on the node (e.g., drone) itself. If a failure occurs (e.g., at any point) the node may start the process over. For example, the node tries again to retrieve the model from the same node. After a threshold number of attempts, the node may attempt to retrieve the model from a different node.

The transmission of information from the operational nodes to the C2 node (e.g., the propagation of a detected object) may use the same or similar operations in reverse to disseminating information (e.g., state updates) through the network. Said differently, just as an instruction and/or model from the C2 node can disseminate through the network, information (e.g., object or target information indicating a detected target) from an operational node can similarly propagate through the network to reach the C2 node. Through this, information may be propagated back to the C2 node. For example, in addition to, or alternative to, an operational node regularly sending push/pull pings to nodes in communication range to receive a state update or model, the node may regularly ping the operational nodes for information for the C2 node. Information for the C2 node may include data describing an object, such as an image of the object (captured by a node) and associated metadata, such as a GPS coordinate of the drone or the target when the image was captured.

An operational node may change its behavior or operations after accomplishing a mission objective (e.g., detecting an object specified by the current mission objective). In a first example, a node which detected a target may continue to track or follow the target. In a second example, a first node may stay within communication range of a second node that previously provided mission accomplishment information (e.g., detection information), for example, to help target information continue to propagate through the network).

A network may include nodes with different roles (e.g., to help achieve a mission objective). Each node may be assigned a role and instructions for each role may be specified by the current state. For example, a first set of one or more nodes has a first role that includes moving through an external environment in a pattern with the intention of detecting an object while a second set of one or more nodes has a second role that includes moving through the external environment in a different pattern with the intention of establishing communications with each of the first set of drones (e.g., the second set of drones may increase the speed at which instructions disseminate through the next work). A C2 node can provide instructions to either of the roles by providing new instructions (e.g., that includes a state update).

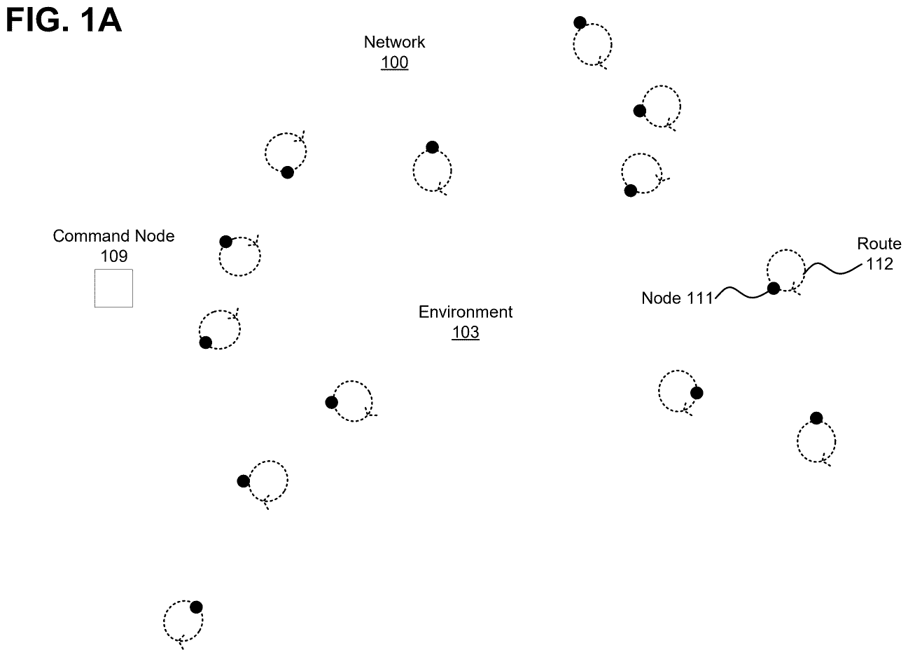

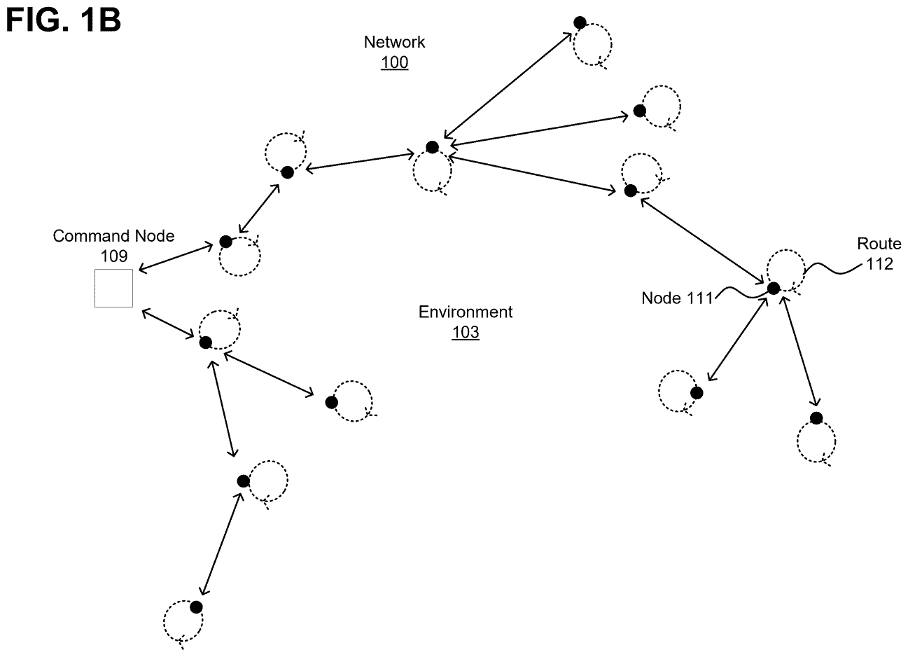

FIG. 1A is a diagram of a network 100 of nodes (e.g., node 111) operating in an environment 103, according to one or more embodiments. Nodes in the network 100 include the command node 109 (which is an example of a C2 node) and operational nodes that receive instructions from the command node 109 (e.g., node 111). In FIG. 1A, the command node 109 is represented by a square and the operational nodes are represented by black dots.

In this example, the command node is stationary. However, this is not required. The operational nodes move through the environment (e.g., each operational node is a vehicle traveling through the environment). In the example of FIG. 1A, each node continuously (e.g., autonomously) travels along a route (e.g., route 112), and each route is similar. The routes are represented by dotted ovals. However, in other embodiments, each operational node may travel along different routes. In general, a route for a node may be predetermined, determined dynamically (e.g., based on data from sensors), random, or any combination thereof.

Additionally, a route for node may be determined by or independent of the current state of a node (or any combination thereof). For example, a node may travel randomly or along a predetermined route through the environment. However, if the node achieves a mission objective (e.g., makes a detection of an object specified by the current state), the node may change its route based on this. For example, if the mission objective is to detect an object, the node may follow the object after the initial detection (and continue making object detections).

FIG. 1B is similar to FIG. 1A except it additionally illustrates how information (e.g., state updates or object detections) propagates through the network 100 between the command node 109 and the operational nodes since most of the operational nodes are outside communication range of the command node 109, according to one or more embodiments. As previously described, nodes asynchronously forwarding information to other nodes allows nodes to receive updated information from and communicate information to the command node 109 without requiring each node to travel within direct communication range of the command node 109.

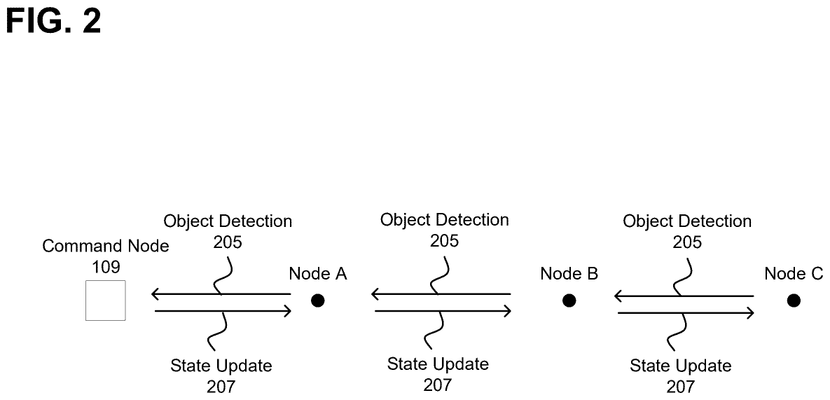

FIG. 2 is a diagram illustrating information communication between the command node 109 and a set of three nodes (labeled node A, node B, and node C), according to one or more embodiments. In this example, node A is in communication range of the command node 109 and node B, node B is additionally in communication range of node C. However, nodes B and C are outside communication range of the command node 109 and node C is additionally outside communication range of node A. Thus, information propagates through the network via the nodes forwarding information to and from the command node 109. In this example, a state update 207 propagates from the command node 109 to node A. Node A updates its state according to the state update 207 and transmits the state update 207 to node B (and any other nodes in the network it may encounter). Similarly, node B updates its state according to the state update 207 and transmits the state update 207 to node C (and any other nodes in the network it may encounter). Node C similarly updates its state according to the state update 207.

In this example, the mission objective according to the updated state is to make a detection of an object (e.g., a specific type of boat). Node C makes a detection of the object. This detection should be transmitted to the command node 109. However, since node C is outside communication range of the command node 109, node C transmits the detection via an object detection 205 to node B (e.g., and any other nodes in the network it may encounter). The object detection 205 may include the detection itself (e.g., an image of the boat captured by a sensor of node C), an indication that a detection of the object was made, metadata related to the detection (e.g., the time and date when the detection was made and the location and orientation of the node when the detection was made, or any combination thereof), or any combination thereof. The object detection 205 may also include an indication to transmit the object detection 205 to the command node 109 (in some embodiments the indication is implied or known by the receiving node). Similarly, since node B is outside communication range of the command node 109, node B forwards the objection detection 205 to node A (e.g., and any other nodes in the network it may encounter). Node A forwards the object detection 205 to the command node 109.

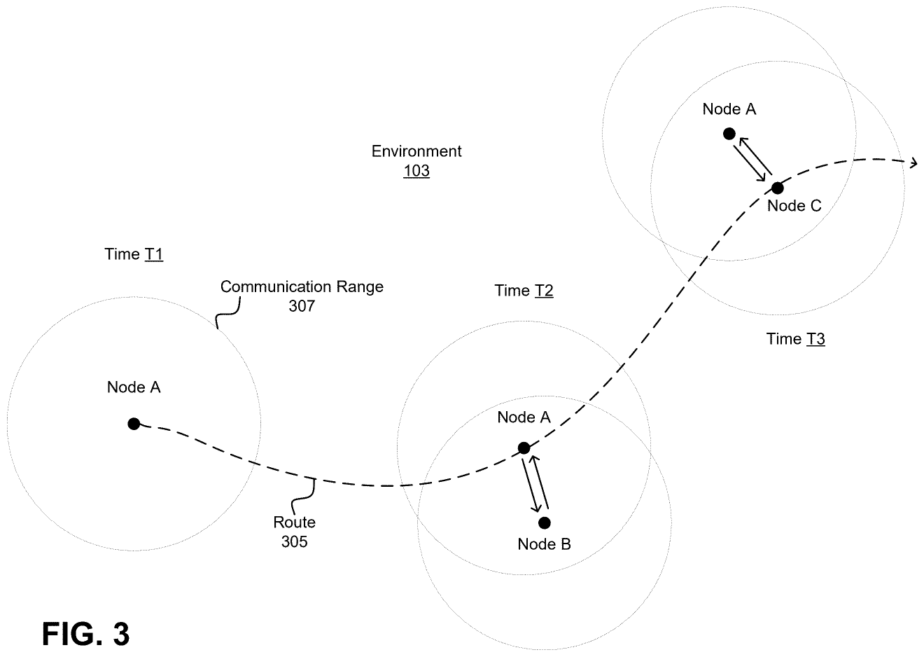

FIG. 3 is a diagram of a node (labeled node A) of the network 100 traveling through the environment 103 and (e.g., automatically) communicating with other nodes in the network 100, according to one or more embodiments. The travel path of node A is route 305 and node A has a set communication range 307. At time T1, node A is not in communication range with any other node. However, as node A travels along the route 305, it encounters node B. At time T2, node A and node B communicate with each other. For example, each node pings the other node to determine their current state. In a specific example, node B has an updated state relative to the state of node A. Responsive to identifying this, node A sends a pull request to node B to receive the updated state. If node A does not have the model associated with the updated state, node A may also request that model from node B.

At time T3, node A encounters node C and communicates with node C. In a specific example, the current state of node A (which it received from node B at time T2) is an updated state relative to the state of node C. Thus, node C receives the updated state from node A. Thus, in this example, communication between the nodes enables the updated state of node B to propagate to nodes A and C as the nodes travel through the environment 103.

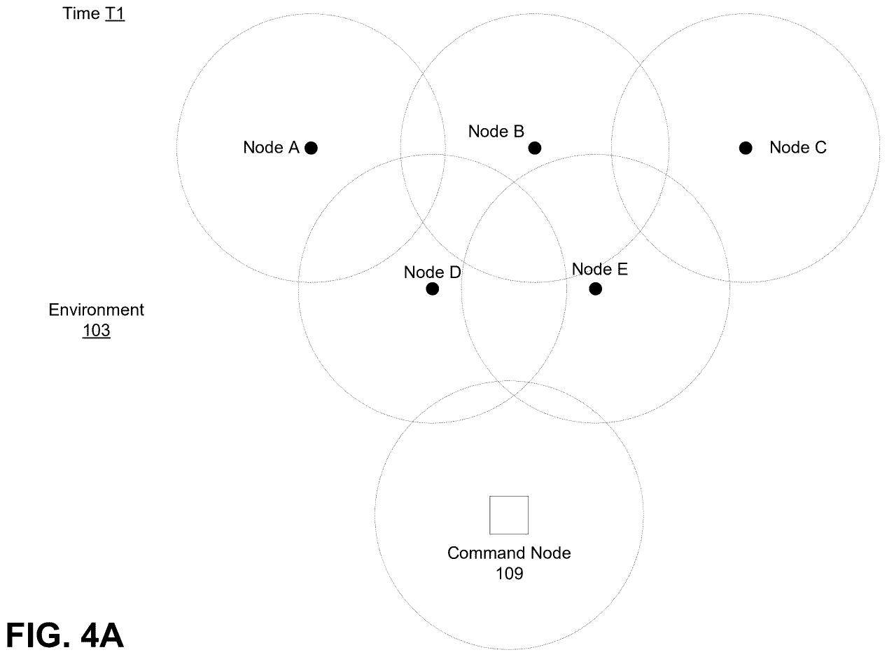

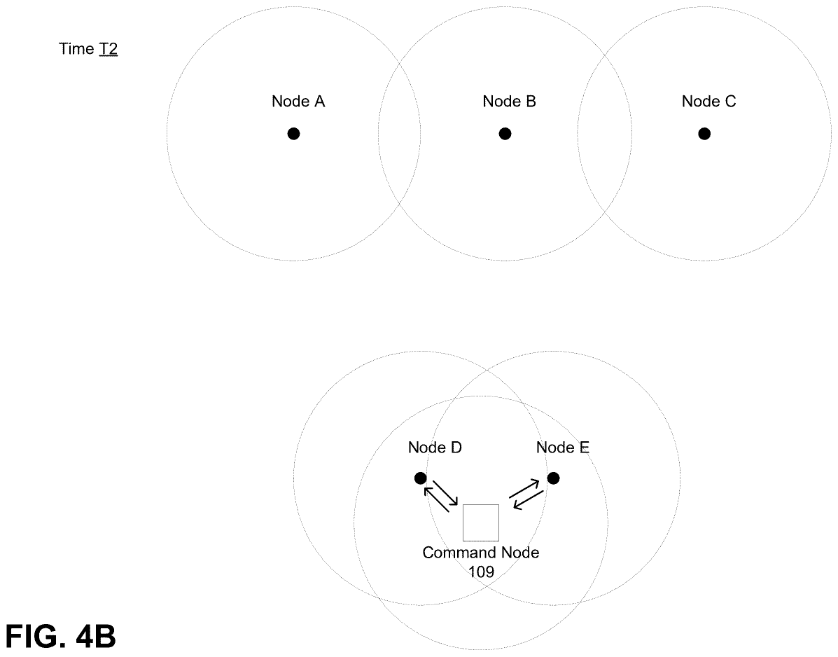

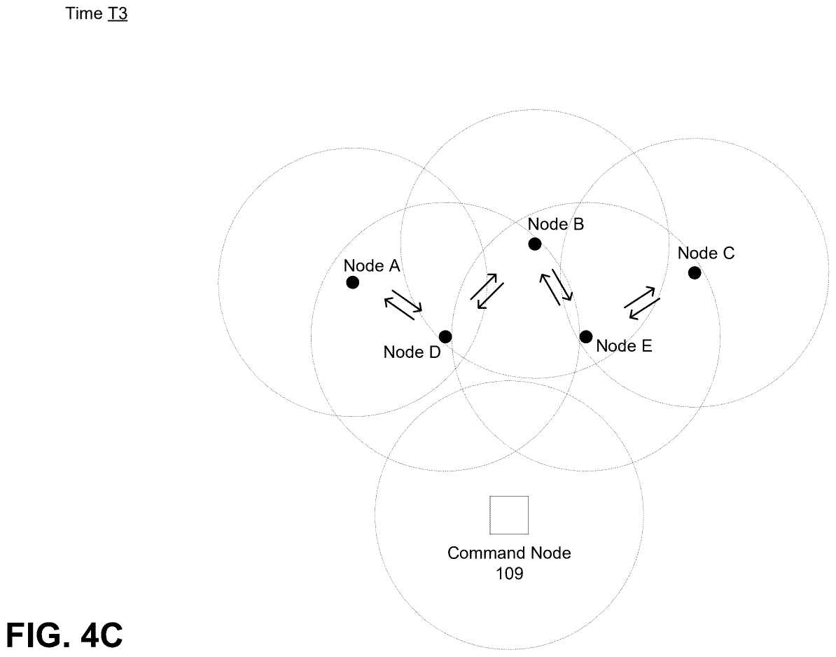

In some embodiments, nodes in a network move along predetermined routes designed to increase the dissemination rate of information across the network or increase the likelihood of nodes receiving updates on a regular basis by establishing predictable communication opportunities between nodes. FIGS. 4A-4C are diagrams that illustrate an example of this, according to one or more embodiments. FIG. 4A illustrates positions of nodes in a network at time T1, FIG. 4B illustrates the positions of nodes at time T2, and FIG. 4C illustrates positions of nodes at time T3. At time T1, none of the nodes are in communication range with each other (the communication ranges are signified by the dotted circles around each node. Among other advantages, having the nodes spread out across in the environment 103 may increase the coverage size of the network and thus increase the ability to achieve one or more mission objectives (e.g., to increase the likelihood of at least one node identifying an object in the environment). At time T2, nodes A, B, and C travel upward to cover more area of the environment 103 while nodes D and E travel downward within communication range of the command node 109 to receive any updates (e.g., state updates) from or provide updates (e.g., object detections) to the command node 109. At time T3, nodes A-E travel toward each other so they become within communication range of each other. This allows nodes D and E to forward any updates from the command node 109 to nodes A, B, and C, and allows nodes A, B, and C to provide any updates for the command node 109 to nodes D and E. Nodes in the network may continue to move in synchronization to the positions indicated at times T1-T3 so that updates can be regularly propagated.

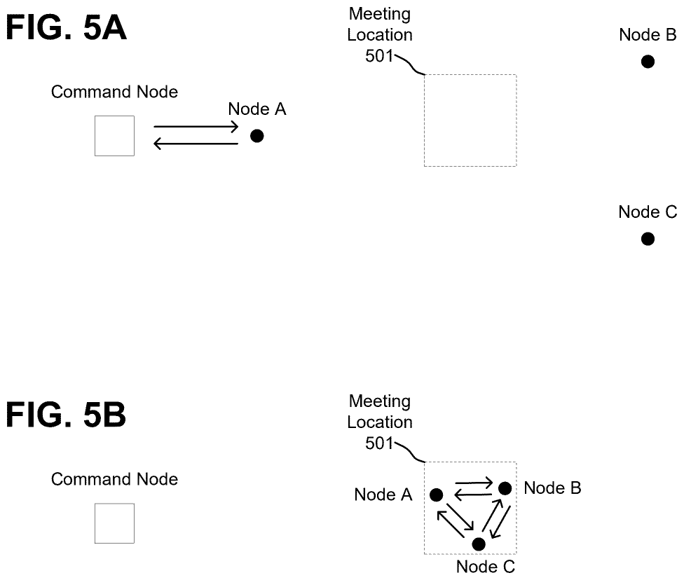

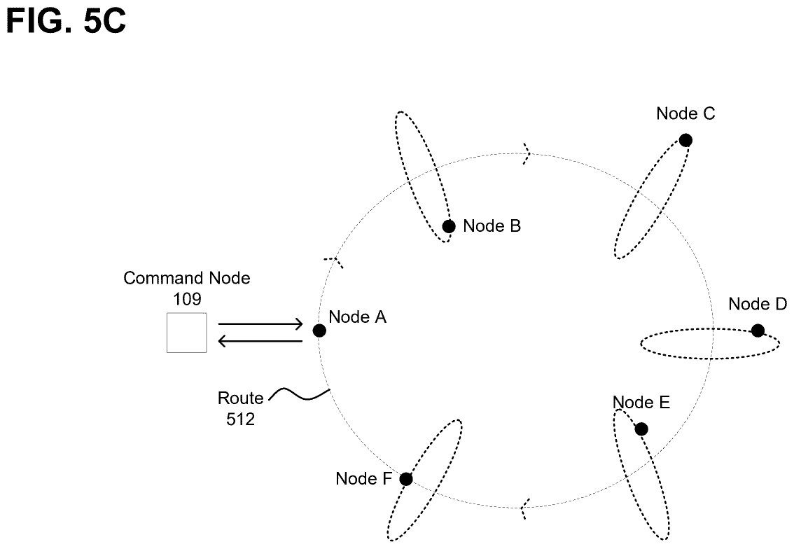

In the above example, the nodes are synchronized to move toward each other (after T2) to communicate updates. However, this is not required. In some embodiments, a network may include meeting locations in the environment and nodes may be instructed to travel to at least one meeting location periodically. For example, FIGS. 5A-5B are diagrams that illustrate nodes traveling to a meeting location 501 to communicate updates to each other.

In some embodiments, a first operational node is instructed to travel through the network to communicate updates between other operational nodes and the command node 109. For example, FIG. 5C illustrates node A with a circular travel route 512 that intersects routes of the other operational nodes in the network, according to one or more embodiments.

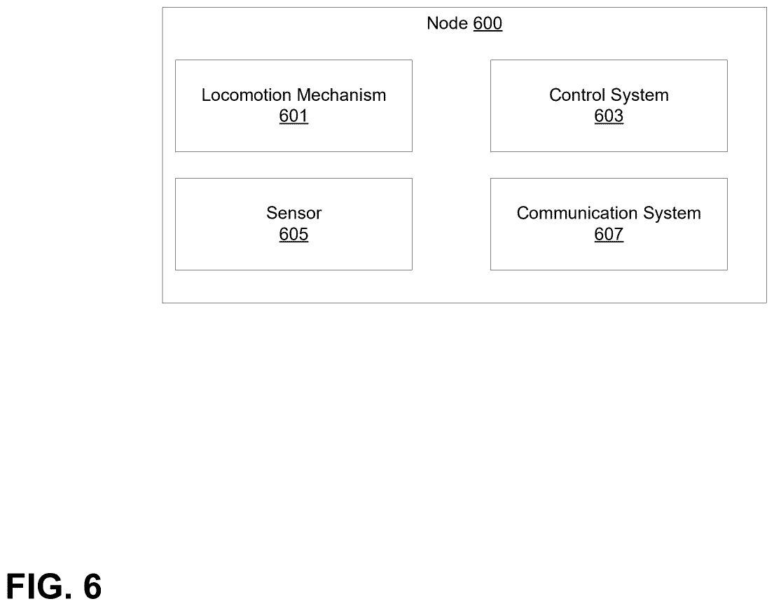

FIG. 6 is a block diagram of a node 600, according to one or more embodiments. The node 600 may be a C2 node or an operational node. Node 600 includes locomotion mechanism 601, control system 603, sensor 605, communication system 607, and storage medium 609. However, the node 600 may have additional, fewer, or different components.

As previously described, a node 600 may be a vehicle that travels through an operating environment. The locomotion mechanism 601 enables the node to move through the environment. The locomotion mechanism 601 may include any number of wings, rotors, propellors, control surfaces, thrusters, rudders, wheels, continuous treads, articulating legs, or some other locomoting mechanism(s). For instance, the node 600 includes a first set and a second set of coaxial wheels, or a first set and a second set of continuous treads. In the either example, the rotational axis of the first and second set of wheels/treads are approximately parallel. Further, each set is arranged along opposing sides of the node 600. The locomoting mechanism 601 may include a drive mechanism (e.g., motor or engine) that causes the locomoting mechanisms to move the node 600 through the operating environment. For instance, the node 600 includes a drive train for rotating wheels or treads.

The control system 603 controls operation of the various components and systems on the node 600. For instance, the control system 603 can obtain information about the operating environment, processes that information to identify an action to implement, and implements the identified action with system components of the node 600.

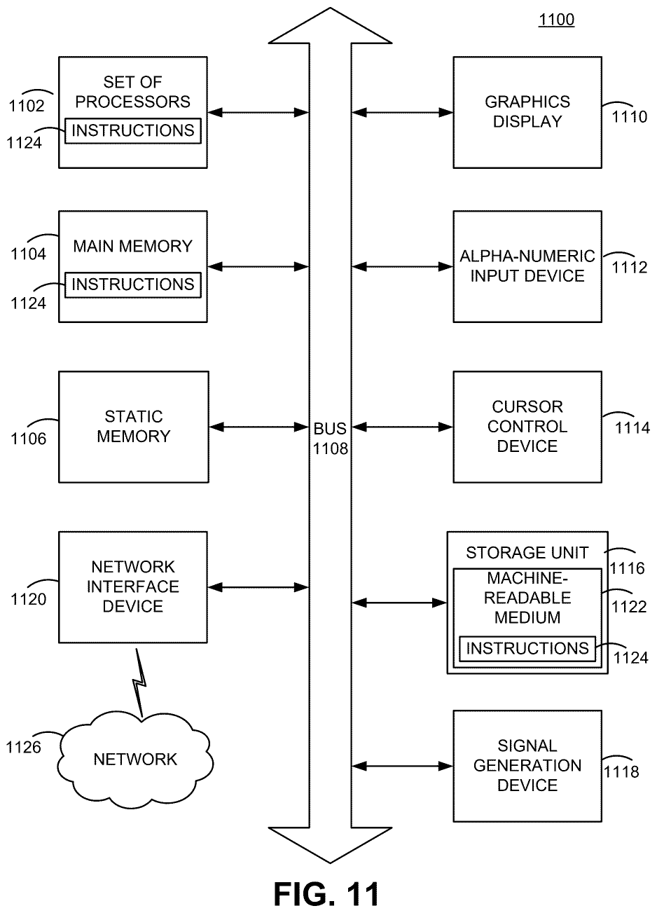

As previously implied, the control system 603 may control the node 600 according to the current state of the node 600. For example, the control system 603 may control the node 600 to accomplish the mission objective. The control system 603 may apply data from the sensor 605 to one or more models to accomplish a mission objective specified by the current state. The control system 603 may be implemented by a computer system (e.g., the computer of FIG. 11), for example that includes a storage medium (e.g., for storing one or more models to be used to accomplish a mission objective).

The sensor 605 generates data describing the environment. For example, the sensor 605 is a multispectral camera, a stereo camera, a CCD camera, a single lens camera, a CMOS camera, hyperspectral imaging system, LIDAR system (light detection and ranging system), a depth sensing system, dynamometer, IR camera, thermal camera, humidity sensor, light sensor, temperature sensor, any other suitable sensor, or any combination thereof. The node 600 may include an array of sensors (e.g., an array of cameras) configured to capture information about the environment (e.g., surrounding the node 600). For example, the node 600 includes an array of cameras configured to capture an array of pictures representing the environment. Additionally, or alternatively, the node 600 may include a sensor that measures an attribute of the node 600. For example, the sensor 605 may be a speed sensor, a heat sensor, or some other sensor that can monitor an attribute of a component of the node 600.

The communication system 607 functions to communicate (e.g., send and/or receive) data between the control system 603 and other nodes in the network. The communication system 607 maybe a Wi-Fi communication system, a cellular communication system, a short-range communication system (e.g., Bluetooth, NFC, etc.), or any other suitable communication system. In some embodiments, the communication system 607 is configured to work with any Layer 3 protocol. In these example embodiments, the Layer 2 and below implementations may be agnostic (e.g., provided there is a Layer 3 addressing scheme). This does include a number of options, which may make it feel generic.

In some embodiments, nodes perform intelligent communication decisions. For example, a node in a network (e.g., in a mesh network) may determine the number of “hops” when choosing which node to pull information from (e.g., a model). For example, fewer hops from the C2 nodes is be preferred.

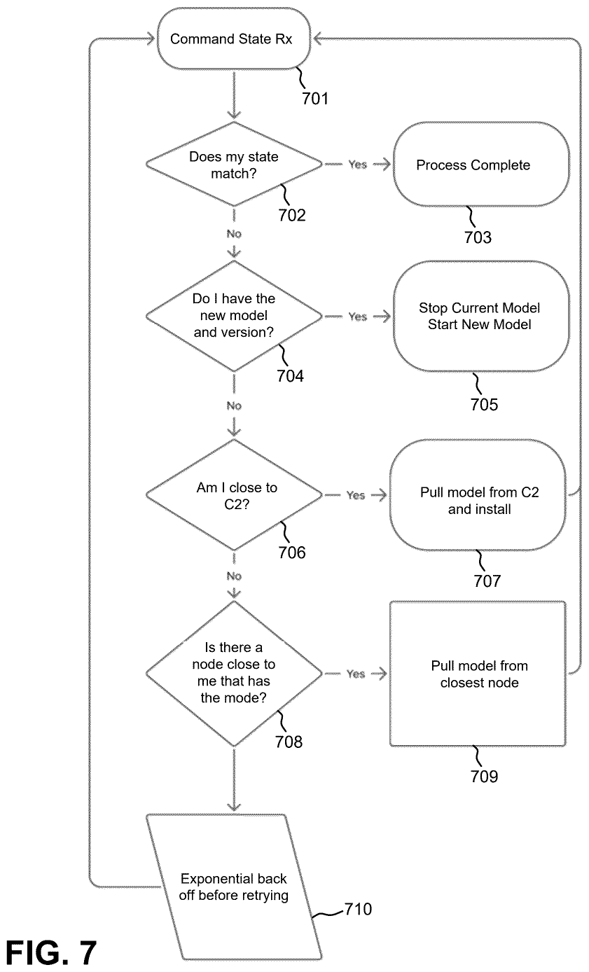

FIG. 7 is a flowchart illustrating an algorithm for a state and model update executed by a node when the current state does not match the running state, according to one or more embodiments. The process begins at step 701 with command state reception (e.g., from another node or the C2 node). At step 702, the node determines whether its current state matches the new state, and if yes, the process completes at step 703. If the states do not match, the node proceeds to step 704 to determine whether it has the new model and version required by the state. If the node has the model for the new state, it stops the current model and starts the new model at step 705. If the node does not have the newmodel, it proceeds to step 706 to determine whether it is close to the C2 node. If the node is close to C2, it pulls the model from C2 and installs it at step 707. If the node is not close to C2, it proceeds to step 708 to determine whether there is a nearby node that has the newmodel. If a nearby node has the model, the node pulls the model from the closest node at step 709. If no nearby node has the model, the node implements an exponential back-off delay before retrying the algorithm at step 710.

### Additional Descriptions

Additional context and descriptions for networks of nodes are described below. The below descriptions provide example embodiments for purposes of illustration only. Any features that are described as essential, important, or otherwise implied to be required should be interpreted as only being required for that particular embodiment and are not necessarily included in other embodiments.

The below descriptions describe example algorithms and processes of transferring models between FPS (Frontline Perception System) enabled platforms a network. In the below descriptions, the network is a mesh network, however this is not required in other in other embodiments.

### FPS Node Types

There is a C2 node within the network (e.g., mesh) which contains (e.g., all of) the configuration, control, and status of the system. In this manner, (e.g., all) other nodes in the network are “dumb,” and receive their configuration from other nodes or from the C2 node directly as a resilient data path. Each operational node will find its own best path to the C2 node automatically. This reduces (e.g., minimizes) configuration and deployment time for a large fleet of nodes (e.g., vehicles), and centralizes an operator of the network on a single interface for the fleet.

In some embodiments, the C2 node has no special hardware requirements other than to be on the same network as the rest of the fleet of operational nodes. It may be as small as a raspberry pi or more commonly a consumer grade laptop.

An operational node may be configured to be an operational node via a configuration flag. An operational node may run AI inference. An operational node may have a GPU on board. In some embodiments, an operational node is a headless, mesh connected device.

### Establishing a Secure Mesh

An aspect of model transfer is the (e.g., secure) mesh for nodes to communicate with each other. In an example first phase of deployment, the mesh is established (e.g., secured) by Layer 2 encryption using radios that support it, as well as an inventory allow-list at the C2 node. In some embodiments, only nodes in the inventory list and on the mesh network are able to communicate within the mesh.

### Distributed of State

Every node in the mesh may contain a compact state of the entire swarm. At a frequency (e.g., of 1 Hz), each node pings for nearby operational nodes to perform a time based diff for each node's state in the mesh. For each operational node in the mesh, two Nodes may compare status and share the record with the newer timestamp. In this manner, each operational node may have the most accurate status available for each node (e.g., as long as there is a daisy chain to propagate the status).

The following example in Table 1 shows a sync between Node A and Node B, resulting in up-to-date telemetry status for both Node A and Node B, but also propagating Node C's status from A to B.

TABLE 1

| | |
|---|---|
| Node A Swarm State | Node B Swarm State |

| | | | |
|---|---|---|---|
| Before Sync | | | |
| Node A Status | 12:01:01:1232 PM | Node A Status | 12:01:00:1232 PM |
| Node B Status | 12:03:01:2340 PM | Node B Status | 12:05:01:2340 PM |
| Node C Status | 12:02:01:1000 PM | Node C Status | 12:01:01:1000 PM |
| After Sync | | | |
| Node A Status | 12:01:01:1232 PM | Node A Status | 12:01:01:1232 PM |
| Node B Status | 12:05:01:2340 PM | Node B Status | 12:05:01:2340 PM |
| Node C Status | 12:02:01:1000 PM | Node C Status | 12:02:01:1000 PM |

The C2 Node initiates the heartbeat style pulses sent over the mesh. By seeding the inventory list to each node, the operational nodes receive the status from C2 which contains the full inventory to observe. In this example, no configuration is used at the operational node.

### Distributed of Commands

The C2 Node propagates a commanded state in the same manner as the operational node telemetry. Using a time based diff, the C2 node may sync the commanded state, including the model to run against the sensor and configuration details for the model. Example options may include to run a different model, change the version of a running model, and whether or not to propagate detections across the mesh to the C2 node.

### Algorithm for Model Update

At a frequency (e.g., of 1 Hz), an operational node may compare its running state to the commanded state from C2. If the commanded state does not match the running state, an algorithm is executed in a non-blocking sub process (e.g., the algorithm of FIG. 7).

### Model and Alert Transfer Details

In some model transfer embodiments, a node shares the bottom three layers of each model on every update. This may results in a file transfer of 20 MB to 50 MB depending on the model and number of classes. In some conditions this is accomplished over a Silvus radio with 4 Mbps at 40 seconds to 2 minutes per model transfer.

When initiating a model update, operational nodes may pull rather than push models. This allows every node to decide based on their own inventory if they need to pull a new model or have it available already. If it is already available, that node becomes a server for the new model to other nearby operational nodes. This process helps avoid having a centralized inventory of models—each operational node figures it out as needed and pulls or serves a model as appropriate.

A node may perform a model validation before running the model to help ensure that the model meets the capabilities of the platform. Upon validation, the model may begin inference immediately. This success status is reported to C2 node and appears in the table view above.

### Failure Scenarios

Model Fails To Complete Download Before Losing Connection. This is a common scenario, where the model fails to complete a file transfer due to network performance. In this event, the operational node may simply retry the algorithm from the beginning, potentially choosing a new node to pull the model from.

Model Fails to Start. The status of failing to start may be reported to the C2 node in the updates. An operator at the C2 may be able to push a different model or roll back as needed.

Reconnecting to the Mesh. If an operational node returns to the mesh after a period of disconnection, within a threshold time period (e.g., 5 seconds) of entering communication (e.g., radio) range with another node, it may receive updated configuration from the mesh. The operational node may take immediate action on this, whether it is pulling a new model from the first node encountered or propagating up any targets found while disconnected.

State conflicts may be resolved by timestamps, which allows a quick resolution of state when nodes enter and leave the mesh and automatically sync their states back to a consistent configuration. In this manner, nodes are resilient to intermittent communications and can (e.g., quickly) recover from any anomalous events in the mesh.

### Example Methods for State Transfer Between Nodes in a Network

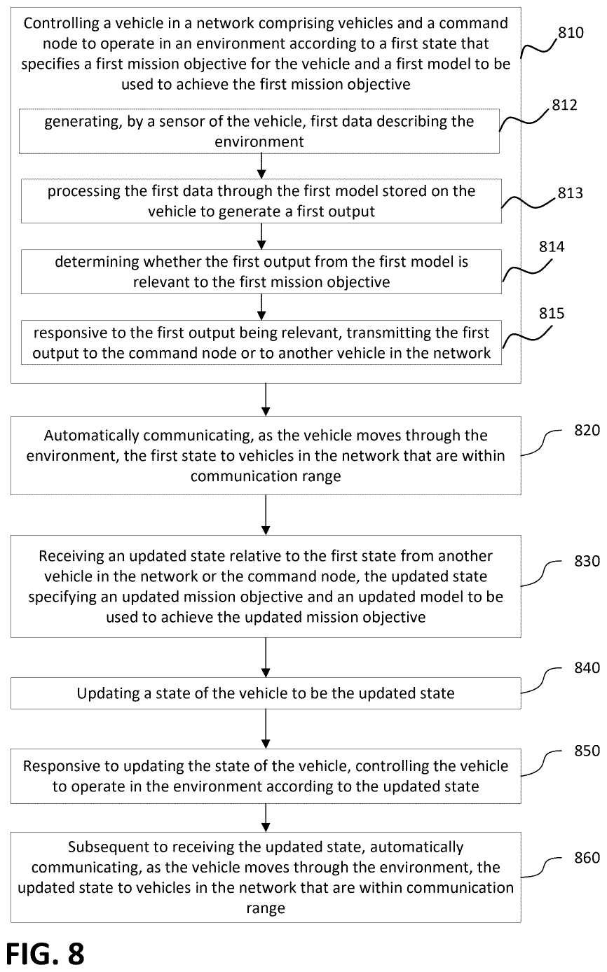

FIG. 8 is a flowchart of an example method according to one or more embodiments. In the example of FIG. 8, the method is performed by a control system (e.g., control system 603) of a vehicle (e.g., the vehicle is an example of node 600), however this is not required. The method can include additional, fewer, or different steps than described. Additionally, the steps can be performed in different order, or by different components than described herein. Additionally, in some embodiments, each of these steps are performed automatically without human intervention.

At step 810, the control system controls a vehicle in a network comprising vehicles and a command node to operate in an environment (e.g., in conjunction with other vehicles in the network) according to a first state that specifies a first mission objective for the vehicle and a first model (e.g., a machine learned model, such as an object detection model) to be used to achieve the first mission objective. Controlling the vehicle according to the first state includes steps 812-815.

At step 812, the control system generates, by a sensor of the vehicle, first data describing the environment.

At step 813 the control system processes the first data through the first model stored on the vehicle (e.g., in a storage medium on the vehicle) to generate a first output.

At step 814, the control system determines whether the first output from the first model is relevant to the first mission objective. For example, the control system identifies that the first output accomplishes the first mission objective. For example, the first output is a detection of an object described by the mission objective (e.g., the model is a machine learned object detection model and the output is an object detection with at least a threshold level of confidence).

At step 815, responsive to the first output being relevant, the control system transmits the first output to the command node or to another vehicle in the network (e.g., with an indication (e.g., instructions) to transmit the first output to the command node),

At step 820, the control system automatically communicates, as the vehicle moves through the environment, the first state to vehicles in the network that are within communication range (e.g., with an indication to operate in the environment according to the first state).

At step 830, the control system receives an updated state relative to the first state from another vehicle in the network or the command node, the updated state specifying an updated mission objective and an updated model to be used to achieve the updated mission objective (e.g., wherein the updated model is a machine learned model, such as an object detection model).

At step 840, the control system updates a state of the vehicle (e.g., from the first state) to be the updated state.

At step 850, the control system, responsive to updating the state of the vehicle, controls the vehicle to operate in the environment according to the updated state (e.g., further comprising ceasing to control the vehicle to operate in the environment according to the first state).

At step 860, the control system, subsequent to receiving the updated state, automatically communicates, as the vehicle moves through the environment, the updated state to vehicles in the network that are within communication range (e.g., with an indication to operate in the environment according to the updated state).

In some embodiments, controlling the vehicle includes receiving the first state directly from the command node or from another vehicle in the network that received the first state from the command node. Additionally, or alternatively, the updated state is received directly from the command node or from another vehicle in the network that received the first state from the command node.

In some embodiments, the method further includes, subsequent to receiving the updated state, the control system determines whether the updated model is stored on the vehicle (e.g., in a storage medium on the vehicle); responsive to the control system identifying the updated model is not stored by the vehicle, it communicates with another vehicle in the network or with the command node to receive the updated model (e.g., via pull requests); and the control system stores the updated model on the vehicle.

In some embodiments, transmitting the first output to the command node or to another vehicle in the network includes: determining whether the command node is in communication range of the command node; responsive to determining that the command node is within communication range, transmitting the first output directly to the command node; and responsive to determining that the command node is outside of communication range, transmitting the first output to another vehicle in the network (e.g., with an indication (e.g., instruction) for the other vehicle to forward the first output to the command node).

In some embodiments, controlling the vehicle to operate in the environment according to the updated state includes: receiving, from the sensor or another sensor of the vehicle, second data describing the environment; processing the second data through the updated model stored on the vehicle (e.g., in a storage medium on the vehicle) to generate a second output; determining whether the second output from the updated model is relevant to the updated mission objective; and responsive to the second output being relevant, transmitting the second output to the command node or to another vehicle in the network (e.g., with an indication (e.g., instructions) to transmit the first output to the command node).

In some embodiments, the method includes the control system at least one of: controlling the vehicle to periodically travel to the command node to receive another updated state from the command node; or controlling the vehicle to periodically travel to a vehicle meeting point in the environment to receive (e.g., or provide) another updated state from another vehicle in the network.

In some embodiments, responsive to receiving a second updated state after receiving the updated state, the control system determines whether the second updated state is a subsequent state relative to the updated state based on a time stamp or version number of the updated state and the second updated state; and responsive to the updated state having a later time stamp or version number relative to the second updated state, the control system maintains the state of the vehicle to be the updated state (e.g., instead of updating the state to be the second updated state).

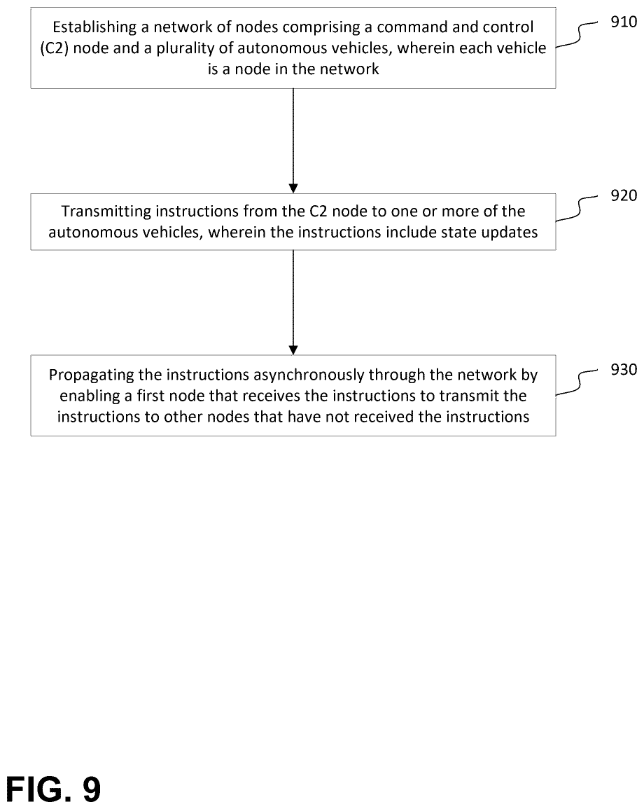

FIG. 9 is a flowchart of an example method for state and model transfer between vehicles in a network. The method can include additional, fewer, or different steps than described. Additionally, the steps can be performed in different order, or by different components than described herein. Additionally, in some embodiments, each of these steps are performed automatically without human intervention.

At step 910, establish a network of nodes comprising a command and control (C2) node and a plurality of autonomous vehicles, where each vehicle is a node in the network.

At step 920, transmit instructions from the C2 node to one or more of the autonomous vehicles, wherein the instructions include state updates.

At step 930, propagate the instructions asynchronously through the network by enabling a first node that receives the instructions to transmit the instructions to other nodes that have not received the instructions.

In some embodiments, a node in the network regularly pinging nodes within communication range to determine whether there are any new instructions from the C2 node. The node updates its state upon receiving an instruction with an updated state, where the updated state specifies a mission objective and a model associated with the mission objective. In some embodiments, the node in the network applies a machine learned object detection model associated with the mission objective to data received from a sensor coupled to the node, where the data includes images, video frames, audio data, or any combination thereof.

In some embodiments, a node in the network receives multiple instructions; and the node in the network determining which instruction to follow based on a timestamp of each instruction, wherein the node follows the instruction with the most recent timestamp.

In some embodiments, the method further includes communicating models between nodes in the network. For example, a node sends pull requests to other nodes to receive a model associated with its updated state.

In some embodiments, communicating a model includes transferring less than the entire model between nodes. Transferring less than the entire model between nodes may include transferring the bottom X number of layers of the model, where X is an integer number greater than zero but less than Y, where Y is the total number of layers of the model (e.g., Y—X layers of the model are not transferred).

In some embodiments, the method further includes, subsequent to a node in the network receiving weights for the bottom X layers of an object detection model configured to detect a first object, modifying an object detection model (a) stored by the node and (b) configured to detect a second object such that the modified object detection model is configured to detect the first object, where X is an integer number greater than zero but less than the total number of layers of the object detection model configured to detect a first object.

In some embodiments, the method further includes a node in a network of nodes receiving a state update from a command and control (C2) node in the network; the node updating its state in accordance with the received state update, wherein the updated state includes the mission objective and a model associated with the mission objective; the node receiving a new model from the C2 node, wherein the new model is associated with the updated state and is configured to perform object detection related to the mission objective; the node applying the new model to data received from sensors coupled to the node, wherein the data includes images, video frames, audio data, or any combination thereof; the node transmitting the received state update and new model to another node in the network.

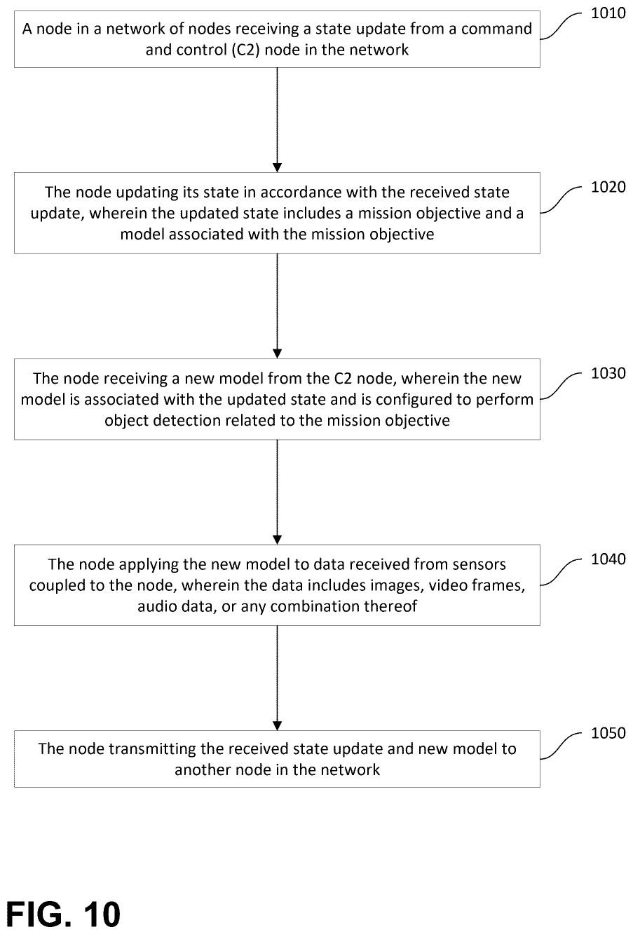

FIG. 10 is a flowchart of an example method for a node in a network to propagate a state update in the network, according to one or more embodiments. The method can include additional, fewer, or different steps than described. Additionally, the steps can be performed in different order, or by different components than described herein. Additionally, in some embodiments, each of these steps are performed automatically without human intervention.

At step 1010, a node in the network of nodes receives a state update from a command and control (C2) node in the network. At step 1020, the node updates its state in accordance with the received state update, where the updated state includes the mission objective and a model associated with the mission objective. At step 1030, the node receiving a new model from the C2 node, where the new model is associated with the updated state and is configured to perform object detection related to the mission objective. At step 1040, the node applies the new model to data received from sensors coupled to the node, where the data includes images, video frames, audio data, or any combination thereof. At step 1050, the node transmits the received state update and new model to another node in the network.

Other aspects include components, devices, systems, improvements, methods, processes, applications, computer readable mediums, and other technologies related to any of the above.

Although the above descriptions refer to autonomous vehicles, the vehicles are not required to be autonomous. Embodiments may be directed to networks of vehicles that include any combination of automatic, semi-automatic, autonomous, semi-autonomous, manually operated (e.g., human operated) vehicles, or any combination thereof. Furthermore, embodiments are not limited to networks of vehicles that move through an environment. For example, embodiments may relate to a network of one or more nodes 600 that do not include locomotion mechanisms 601.

Although the above descriptions refer to machine learned object detection models, the models are not required to be object detection models. For example, embodiments may be directed to other types of models, such as fusion models configured to fuse sensor data from different sensors together (e.g., data from a radio wave sensor (e.g., a radar sensor) and data from a visual sensor (an image sensor or event camera)).

### Computing Machine Architecture

FIG. 11 is a block diagram illustrating components of an example machine able to read instructions from a machine-readable medium and execute them in a set of one or more processors (or controllers), according to one or more embodiments. Specifically, FIG. 11 shows a diagrammatic representation of a machine in the example form of a computer system 1100 within which instructions 1124 (e.g., software) for causing the machine to perform any one or more of the methodologies discussed herein may be executed (e.g., any of the flowcharts of FIGS. 7-10). Examples of the computer system 1100 include control systems (e.g., 603) of nodes of a network, as previously described. The program code may be comprised of instructions 1124 executable by a set of one or more processors 1102. In some embodiments, the set of one or more processors 1102 includes multiple processors. In these embodiments, the processors may work individually or collectively to perform operations. In various embodiments, the machine operates as a standalone device or may be connected (e.g., networked via the network 1126) to other machines (e.g., nodes). In a networked deployment, the machine may, for example, operate in the capacity of a server machine or a client machine in a server-client network environment or as a peer machine in a peer-to-peer (or distributed) network environment. In the context of a particular machine some or all the components illustrated and described with FIG. 11 may be applicable.

The machine may be, for example, a server computer, a client computer, a personal computer (PC), a tablet PC, a personal digital assistant (PDA), a cellular telephone, a smartphone, a web appliance, a network router, switch or bridge, a node or any machine capable of executing instructions 1124 (sequential or otherwise) that specify actions to be taken by that machine. Further, while only a single machine is illustrated, the term “machine” shall also be taken to include any collection of machines that individually or jointly execute instructions 1124 to perform any one or more of the methodologies discussed herein.

The example computer system 1100 includes a set of one or more processors 1102 (e.g., one or more central processing units (CPUs), one or more graphics processing units (GPUs), one or more digital signal processors (DSPs), one or more application specific integrated circuits (ASICs), one or more radio-frequency integrated circuits (RFICs), or any combination of these), a main memory 1104, and a static memory 1106, which are configured to communicate with each other via a bus 1108. The computer system 1100 may further include a visual display interface 1110. The visual display interface 1110 may include a software driver that enables displaying one or more user interfaces on one or more screens (or displays). The visual display interface 1110 may display user interfaces directly (e.g., on the screen) or indirectly on a surface, window, or the like (e.g., via a visual projection unit). For ease of discussion, the visual display interface 1110 may be described as a screen or a display panel. The visual display interface 1110 may include or may interface with a touch-enabled screen. The computer system 1100 may also include alphanumeric input device 1112 (e.g., a keyboard), a cursor control device 1114 (e.g., a mouse, a trackball, a joystick, a motion sensor, or other pointing instrument), a storage unit 1116, a signal generation device 1118 (e.g., a speaker), and a network interface device 1120, which also are configured to communicate via the bus 1108.

The storage unit 1116 includes a (e.g., non-transitory) machine-readable medium 1122 on which is stored instructions 1124 (e.g., software) embodying any one or more of the methodologies or functions described herein. The instructions 1124 (e.g., software) may also reside, completely or at least partially, within the main memory 1104 or within the processor 1102 (e.g., within a processor's cache memory) during execution thereof by the computer system 1100, the main memory 1104 and the processor 1102 also constituting machine-readable media. The instructions 1124 (e.g., software) may be transmitted or received over a network 1126 via the network interface device 1120.

While machine-readable medium 1122 is shown in an example embodiment to be a single medium, the term “machine-readable medium” should be taken to include a single medium or multiple media (e.g., a centralized or distributed database, or associated caches and servers) able to store instructions (e.g., instructions 1124). The term “machine-readable medium” shall also be taken to include any medium that is capable of storing instructions (e.g., instructions 1124) for execution by the machine and that cause the machine to perform any one or more of the methodologies disclosed herein. The term “machine-readable medium” includes, but is not limited to, data repositories in the form of solid-state memories, optical media, and magnetic media.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) and/or hardware modules. Code (e.g., comprising instructions) of a software module may be executable by a processor system (e.g., a set of one or more processors). A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It may be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by a set of one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The set of one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the set of one or more processors, not only residing within a single machine, but deployed across a number of machines. In some example embodiments, the set of one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

What is claimed is:

1. One or more non-transitory computer-readable storage mediums storing instructions that, when executed by a set of one or more processors, cause the set of one or more processors to:
control a vehicle in a network comprising a plurality of vehicles and a command node to operate in an environment according to a first state specifying a first mission objective for the vehicle and a first model to be used to achieve the first mission objective, wherein to control the vehicle, the one or more non-transitory computer-readable storage mediums includes instructions that cause the set of one or more processors to:
receive, by a sensor of the vehicle, first data describing the environment;
process the first data through the first model stored on the vehicle to generate a first output;
determine whether the first output from the first model is relevant to the first mission objective; and
responsive to the first output being relevant, transmit the first output to the command node or to another vehicle in the network;
automatically communicate, as the vehicle moves through the environment, the first state to vehicles in the network that are within communication range;
receive an updated state relative to the first state from another vehicle in the network or the command node, the updated state specifying an updated mission objective and an updated model to be used to achieve the updated mission objective;
update a state of the vehicle to be the updated state;
responsive to the update to the state of the vehicle, control the vehicle to operate in the environment according to the updated state; and
subsequent to receipt of the updated state, automatically communicate, as the vehicle moves through the environment, the updated state to vehicles in the network that are within communication range.

2. The one or more non-transitory computer-readable storage mediums of claim 1:
wherein to control the vehicle, the one or more non-transitory computer-readable storage mediums includes instructions that cause the set of one or more processors to:
receive the first state directly from the command node or from another vehicle in the network that received the first state from the command node; and
wherein the updated state is received directly from the command node or from another vehicle in the network that received the first state from the command node.

3. The one or more non-transitory computer-readable storage mediums of claim 1, where the one or more non-transitory computer-readable storage mediums includes further instructions that cause the set of one or more processors to:
subsequent to receipt of the updated state, determine whether the updated model is stored on the vehicle;
responsive to an identification that the updated model is not stored on the vehicle, communicate with another vehicle in the network or with the command node to receive the updated model; and
store the updated model on the vehicle.

4. The one or more non-transitory computer-readable storage mediums of claim 1, wherein to transmit the first output to the command node or to another vehicle in the network, the one or more non-transitory computer-readable storage mediums includes instructions that cause the set of one or more processors to:
determine whether the command node is in communication range of the command node;
responsive to a determination that the command node is within communication range, transmit the first output directly to the command node; and
responsive to a determination that the command node is outside of communication range, transmit the first output to another vehicle in the network.

5. The one or more non-transitory computer-readable storage mediums of claim 1, wherein to control the vehicle to operate in the environment according to the updated state, the one or more non-transitory computer-readable storage mediums includes instructions that cause the set of one or more processors to:
receive, from the sensor or another sensor of the vehicle, second data describing the environment;
process the second data through the updated model stored on the vehicle to generate a second output;
determined whether the second output from the updated model is relevant to the updated mission objective; and
responsive to the second output being relevant, transmit the second output to the command node or to another vehicle in the network.

6. The one or more non-transitory computer-readable storage mediums of claim 1, wherein the one or more non-transitory computer-readable storage mediums further includes instructions that cause the set of one or more processors to at least one of:
control the vehicle to periodically travel to the command node to receive another updated state from the command node; or
control the vehicle to periodically travel to a vehicle meeting point in the environment to receive another updated state from another vehicle in the network.

7. The one or more non-transitory computer-readable storage mediums of claim 1, wherein the one or more non-transitory computer-readable storage mediums further includes instructions that cause the set of one or more processors to:
responsive to receipt of a second updated state after receipt of the updated state, determine whether the second updated state is a subsequent state relative to the updated state based on a time stamp or version number of the updated state and the second updated state; and
responsive to the updated state having a later time stamp or version number relative to the second updated state, maintain the state of the vehicle to be the updated state.

8. A method comprising:
controlling a vehicle in a network comprising vehicles and a command node to operate in an environment according to a first state that specifies a first mission objective for the vehicle and a first model to be used to achieve the first mission objective, wherein controlling the vehicle comprises:
generating, by a sensor of the vehicle, first data describing the environment;
processing the first data through the first model stored on the vehicle to generate a first output;
determining whether the first output from the first model is relevant to the first mission objective; and
responsive to the first output being relevant, transmitting the first output to the command node or to another vehicle in the network;
automatically communicating, as the vehicle moves through the environment, the first state to vehicles in the network that are within communication range;
receiving an updated state relative to the first state from another vehicle in the network or the command node, the updated state specifying an updated mission objective and an updated model to be used to achieve the updated mission objective;
updating a state of the vehicle to be the updated state;
responsive to updating the state of the vehicle, controlling the vehicle to operate in the environment according to the updated state; and
subsequent to receiving the updated state, automatically communicating, as the vehicle moves through the environment, the updated state to vehicles in the network that are within communication range.

9. The method of claim 8:
wherein controlling the vehicle comprises:
receiving the first state directly from the command node or from another vehicle in the network that received the first state from the command node; and
wherein the updated state is received directly from the command node or from another vehicle in the network that received the first state from the command node.

10. The method of claim 8, further comprising:
subsequent to receiving the updated state, determining whether the updated model is stored on the vehicle;
responsive to identifying the updated model is not stored by the vehicle, communicating with another vehicle in the network or with the command node to receive the updated model; and
storing the updated model on the vehicle.

11. The method of claim 8, wherein transmitting the first output to the command node or to another vehicle in the network comprises:
determining whether the command node is in communication range of the command node;
responsive to determining that the command node is within communication range, transmitting the first output directly to the command node; and
responsive to determining that the command node is outside of communication range, transmitting the first output to another vehicle in the network.

12. The method of claim 8, wherein controlling the vehicle to operate in the environment according to the updated state comprises:
receiving, from the sensor or another sensor of the vehicle, second data describing the environment;
processing the second data through the updated model stored on the vehicle to generate a second output;
determining whether the second output from the updated model is relevant to the updated mission objective; and
responsive to the second output being relevant, transmitting the second output to the command node or to another vehicle in the network.

13. The method of claim 8, further comprising at least one of:
controlling the vehicle to periodically travel to the command node to receive another updated state from the command node; or
controlling the vehicle to periodically travel to a vehicle meeting point in the environment to receive another updated state from another vehicle in the network.

14. The method of claim 8, further comprising:
responsive to receiving a second updated state after receiving the updated state, determining whether the second updated state is a subsequent state relative to the updated state based on a time stamp or version number of the updated state and the second updated state; and
responsive to the updated state having a later time stamp or version number relative to the second updated state, maintaining the state of the vehicle to be the updated state.

15. A vehicle configured to be in a network comprising vehicles and a command node, the command node configured to provide control instructions to vehicles in the network, the vehicle further configured to:
operate in an environment according to a first state that specifies a first mission objective for the vehicle and a first model to be used to achieve the first mission objective, wherein to operate in the environment according to the first state, the vehicle is further configured to:
receive, from a sensor of the vehicle, first data describing the environment;
process the first data through the first model stored on the vehicle to generate a first output;
determine whether the first output from the first model is relevant to the first mission objective; and
responsive to the first output being relevant, transmit the first output to the command node or to another vehicle in the network;
automatically communicate, as the vehicle moves through the environment, the first state to vehicles in the network that are within communication range;
receive an updated state relative to the first state from another vehicle in the network or the command node, the updated state specifying an updated mission objective and an updated model to be used to achieve the updated mission objective;
update a state of the vehicle to be the updated state;
responsive to the update to the state of the vehicle, control the vehicle to operate in the environment according to the updated state; and
subsequent to receipt of the updated state, automatically communicate, as the vehicle moves through the environment, the updated state to vehicles in the network that are within communication range.

16. The vehicle of claim 15:
wherein vehicle is further configured to:
receive the first state directly from the command node or from another vehicle in the network that received the first state from the command node; and
wherein the updated state is received directly from the command node or from another vehicle in the network that received the first state from the command node.

17. The vehicle of claim 15, wherein the vehicle is further configured to:
subsequent to receipt of the updated state, determine whether the updated model is stored on the vehicle;
responsive to an identification that the updated model is not stored on the vehicle, communicate with another vehicle in the network or with the command node to receive the updated model; and
store the updated model on the vehicle.

18. The vehicle of claim 15, wherein to transmit the first output to the command node or to another vehicle in the network, the vehicle is further configured to:
determine whether the command node is in communication range of the command node;
responsive to a determination that the command node is within communication range, transmit the first output directly to the command node; and
responsive to a determination that the command node is outside of communication range, transmit the first output to another vehicle in the network.

19. The vehicle of claim 15, wherein to operate in the environment according to the updated state, the vehicle is further configured to:
receive, from the sensor or another sensor of the vehicle, second data describing the environment;
process the second data through the updated model stored on the vehicle to generate a second output;
determined whether the second output from the updated model is relevant to the updated mission objective; and
responsive to the second output being relevant, transmit the second output to the command node or to another vehicle in the network.

20. The vehicle of claim 15, wherein the vehicle is further configured to at least one of:
periodically travel to the command node to receive another updated state from the command node; or
periodically travel to a vehicle meeting point in the environment to receive another updated state from another vehicle in the network.
